(19) United States
(12) Patent Application Publication
(10) Pub. No.: US 2011/0173174 A1
(43) Pub. Date: Jul. 14, 2011

(54) LINGUISTICALLY ENHANCED SEARCH ENGINE AND META-SEARCH ENGINE

(75) Inventor: Daniel Ian FLITCROFT, Dublin (IE)

(73) Assignee: Flitcroft Investments Ltd, Bride's Glen (IE)

(21) Appl. No.: 13/005,887

(22) Filed: Jan. 13, 2011

Related U.S. Application Data
(60) Provisional application No. 61/294,720, filed on Jan. 13, 2010.
(60) Provisional application No. 61/346,937, filed on May 21, 2010.

(51) Int. Cl. G06F 17/30

(52) U.S. Cl. 707/707; 707/E17.108

(57) ABSTRACT

A search enhancement system (whether linked through an API to a search engine or integral to a search engine) creates a series of different narrow searches through the selective use of synonyms, hyponyms for a narrower search, hypernyms for a broader search, and antonyms for a reverse search. Lexical analysis can also be used to create alternative narrow searches. This allows a user to explore different nuances of meaning in an original search phrase until the user finds what he or she wants, while keeping individual searches narrow, thus leading to more focused search results.

The disclosed apparatuses and methods (herein “search enhancement system”) relate to enhancing search engines and/or meta-search engines and, more particularly, to a system that can facilitate varying search parameters and thereby search results returned from a search engine or meta-search engine by application of linguistic algorithms to a search query.

### DESCRIPTION OF THE RELATED ART

The dominance of a few very successful search engines has made web searching much less frustrating in recent years but has led to a situation where if a user searches repeatedly on a specific topic they tend to see the same results over and over again. An experienced searcher will know how to vary the terms of a search query but this is by no means true of the average user of such services, and the process is time consuming.

Another important development in the field of search engine technology has been the publication of programming interfaces (API's) for popular search engines such as GOOGLE and YAHOO. This has allowed the development of new applications that provide alternative interfaces to established search engines and add a range of features to search. Meta-search engines can simultaneously search across several search providers on the back of a single search query and present the results to a user. Examples include EXCITE, METACRAWLER, DOGPILE, INFERENCE FIND, SAVVYSEARCH and FUSION (see, cryer.co.uk/resources/searchengines/meta.htm on the World Wide Web for a fuller list). Such meta-search engines attempt to differentiate themselves primarily in the way in which they present the results. Custom search engines can provide an alternative search experience while still using one of the main search providers API such as GOOGLE to access the results. Such engines often are specific to one area of interest or topic and can be setup to search a specific list of websites rather than the entire web.

People use search engines for different reasons. Sometimes to look at something very specific for which engines such as GOOGLE or BING prove extremely valuable when the right search terms are used. Other times people are looking inspiration or for something that is a little different to what everyone might be finding, e.g., for an article or project, particularly those efforts that require nuanced results, such as patent searching. If researching for a paper or article there is little point in presenting material that can be found instantly in a GOOGLE search. The present inventor perceives a need for an alternative method of finding information from a search engine or database.

### BACKGROUND OF DISCLOSED SEARCH ENGINE

A range of solutions have been invented to assist in the process of web search. For instance, an auto-complete feature of many search engines now provides a drop down list of commonly searched phrases but these are populated from previously entered searches so that this feature, although helpful, directs people to the most commonly searched phrases and commonly accessed sites. These suggestions are generally based on statistical frequency, rather than linguistic interrelationships. In addition, these suggestions can run contrary to a purpose of the current system, which is to explore the nuances of a search phrase and find out useful content that is effectively hidden as it does not rank highly on search engine listings. The current system helps to locate search results as they are referenced by unusual variants or combinations of more common words. As such unusual variants and combinations are, by definition, rarely searched they are not featured in auto-complete lists or list of common search terms GOOGLE's website description (google.com/support/websearch/bin/answer.py?h1=en&answer=106230 on the Web) indicates that the current GOOGLE auto-complete feature operates on the following basis: As a user types, GOOGLE's algorithm predicts and displays search queries based on other users' search activities. These searches are algorithmically determined based on a number of purely objective factors (including popularity of search terms) without human intervention. All of the predicted queries shown have been typed previously by other GOOGLE users. The auto-complete dataset is updated frequently to offer fresh and rising search queries. In addition, if a user is signed-in to his or her GOOGLE account and have Web History enabled, a searcher may see search queries from relevant searches that you've done in the past. This feature is therefore based on prior use and by definition will direct a user to a search result that has likely substantively already been presented.

A well known form of altering a search on the web or database is query expansion or word stemming. As described at the following web address, dba-oracle.com/t_search_engine_word_stemming_synonyms.htm on the World Wide Web, word stemming is defined as the ability to include word variations. For example any noun-word would include variations (whose importance is directly proportional to the degree of variation). With word stemming, one uses quantified methods for the rules of grammar to add word stems and rank them according to their degree of separation from the root word. For example, one might see stems identified for “cheap”, “condo” and “check”:

(cheap or cheaper)

AND

(condo and condos)

AND

(check and checked and checking)

Synonym Expansion is where variants of the word are taken and assigned to the search engine query. Retuning to our example, the term “cheap” might indicate that the searcher is also interested in similar terms for a low cost:

cheaper

or

inexpensive

or

“low cost”

or

bargain

Similarly, the term “condo” might indicate that the searcher is also interested in similar types of housing:

condo

or

apartment

or

flat

or

“rental property”

When a query is expanded a complex word search expression is developed for the base engine. In the case of the simple “cheap condo Los Angeles no credit check”, this search is transformed into a far more complex Boolean form:

(cheap or cheaper)
AND

(condo and condos)
AND

(check and checked and checking)
AND

(cheaper or inexpensive or “low cost” or bargain)
AND

(condo or apartment or flat or “rental property”)

Additionally, the search can be expanded by adding stems of the synonyms:
AND

(apartment or apartments)
AND

(bargains or bargain or bargaining)

As described about word-stemming generates broader searches than the original using the Boolean “or” search term to expand the search query with identified synonyms. For example U.S. Pat. No. 6,845,372 addresses the need for what is described as “impatient” Internet users by using word stemming to include all possible terms in a single search. In U.S. Pat. No. 7,171,351, a search engine expands the query by including synonyms of the terms to obtain expanded terms, hence broadening a search. It is this lack of specificity and broadness of word-stemmed or expanded searches that is a principal reason for the lack of word stemming by Web search engines.

Lexical analysis of search terms has also been described as a way of normalizing a search phrase into a standard phrase (U.S. Pat. No. 6,519,585) to facilitate categorization of search results. Another application of using synonyms in searching is disclosed in U.S. Pat. No. 7,133,866. In this application, when a user enters the symptom of a problem, it is mapped to possible synonyms to identify a symptom for which a database contains a solution so a user can be presented a possible solution. This is another form of search term normalization. In this case, the synonym used for the search query is selected so as to match a generic problem with a pre-identified solution. This is a highly constrained situation which cannot be applied for general search engines.

### SUMMARY OF THE DISCLOSED SEARCH ENHANCEMENT SYSTEM

In contrast to the search expansion tools described above, certain embodiments of the presently disclosed search enhancement system (whether linked through an API to a search engine or integral to a search engine) creates a series of different narrow searches. Lexical analysis can be used to create alternative narrow searches rather than broader searches as done in the past. This allows a user to explore different nuances of meaning in an original search phrase until the user finds what he or she wants, while keeping individual searches narrow rather than broad, thus leading to more focused search results.

Various exemplary embodiments of the presently disclosed search enhancement system can provide alternative search experiences from standard search engines or databases of Internet content. Various exemplary embodiments of the presently disclosed search enhancement system can provide a search method that improves on the ability of existing search methods to find web-pages and other resources that would not normally be found on a standard web-search.

These and related capabilities can be achieved by the disclosed computer implemented search enhancement system, as both search apparatus and search method. With this method the search phrase entered by a user is re-cast or re-phrased by predefined software algorithms prior to submission to the search engine or database by making word substitutions using synonyms, hypernyms (words of a broader sense than the original, e.g., greeting is a hypernym of hello) and hyponyms (words of a narrower or more specific meaning, e.g., France is a hyponym of country), as examples. A user may select between one or more algorithms, or they may be predetermined for a specific type of search page. Alternatively the final algorithm can be determined by analysis of the search phrase itself.

For example using a simple very broad synonym search for a single word but an algorithm that incorporates grammar and semantic analysis for a longer phrase of several words. These algorithms analyze the original search phrase word by word to create an alternative search query by replacing where possible each word with an alternative word or phrase. Alternatively a phrase may be replaced by a shorter phrase or a single word. These alternatives can generated according predefined rules, randomized from predefined lists or extracted from a relational database such as WORDNET (a database created by Princeton University) or a database created for a particular purpose, technology or industry, which allows a range of synonyms, hypernyms, hyponyms or alternative phrases to be identified for a very large range of words. These lists of semantically related words can also include common misspellings or regional variants of words (e.g., colour and color) to ensure a fully comprehensive list. Importantly these alternatives are generated by linguistic or semantic similarity to the original phrase and not based a database of commonly or previously searched phrases. Once the alternative phrase is generated it is this new phrase that is forwarded to one or more search engines or used to directly query a database of Internet content or a specific database or list of databases of other content. The results can be presented to the user as originally intended by the search engine or according to a wide range of currently used methods.

Exemplary embodiments of the presently disclosed search enhancement system can include a specific form of interface in which alternative words and phrases are presented on a set of dials (or other suitable way to graphically show groups of terms relative to each other) to allow a user to explore this large dataset of possible phrases. Effectively this is a tool that allows a user to change a single search phrase and list of results into a set of search phrases and a multidimensional set of search results which can be browsed until the appropriate type of search phrase and type of results are obtained. Further, depending on embodiment and/or option selected by the user, simply changing the position of the dial will result in the presentation of new search results without further action by the user, thus greatly speeding up alternative narrow search results.

After one set of results are presented a user can re-search with the original search phrase a number of times because for most search phrases a wide variety of alternatives can be located due to the combinatorial nature of the process. For example if a four word phrase has 5 alternatives words for word #1, 7 for word #2, 10 for word #3 and 2 for word #4, this creates 5×7×10×2 alternative search phrases or 700 different potential searches for the same original search phrase. Each generated search phrase will be narrow but will carry a differently nuanced meaning. Computers are generally ill-suited for identifying nuance in language but with this method the user can identify when the correct nuance have been achieved with a given alternative search phrase on the basis of the type of results that have been generated. As with standard search engines the results contain hypertext links so that a user can visit and explore the most interesting of the returned results. Some existing search engines already provide a thumbnail of what a website looks like before a user visits. In the context of the current invention where a user is trying to locate unusual or neglected sites as well as the more popular it is useful to provide additional information on the level of interest a site has garnered. This is done by determining which results have been most commonly visited or have the most citations in social sites such as TWITTER or FACEBOOK and extracting such comments. This information can be presented to the user before they decide to click on a specific link in a pop-up or overlay window when a mouse cursor is over the link but prior to a mouse click. Alternatively an icon or text link to this additional information can be inserted alongside the search results. This feature allows a user to explore sites that have generated the most interest and also, just as importantly, to identify interesting and relevant sites that have received little or no comment in social media. As an added tool to explore a search space this facility can also be extended to include website suggestions for semantically similar website where such semantic indexing data is available. For that same search phrase all the standard search engines would return only a single set of results indicating the power of the current invention to unearth new and sometimes surprising results. Performing a standard search with the original search phrase can be offered as an option so the user can compare the results of a standard search with the results obtained from the alternative search phrase. Users can also select for have the results presented side-by-side for more direct comparison of a standard search and a search with a modified search phrase.

In some of the embodiments the substitute terms are selected randomly from the list of alternative terms. In some of the embodiments, certain terms are excluded from substitution. Some these excluded terms may be included in a predefined set, such as Boolean operators and pronouns. Other terms can be excluded from substitution based on grammar rules (e.g., capitalization, proper nouns or punctuation). Terms can also be excluded from substitution by selection by a user, and the user can exclude selected words or phrases as substitutes, depending on implementation.

In some of the embodiments, a particular search enhancement system may have a predefined set of search algorithms. Furthermore, a user may select between the predefined algorithms. Alternatively, an algorithm can be automatically determined based on the information included in a user's search query. In some of the embodiments, an interactive computer-user interface presents a user with a set of dials having respective sets of alternative words and queries. By rotating the dial on screen, alternative terms can be reviewed and used. In some embodiments switching between terms automatically cause the search to execute using the alternative term without further action by the user, such that the alternative search results are displayed without human delay. Dials are only one type of interface. Sliding scales, rotary wheels and virtually any other form of relating individual members of one group of terms against individual members of another group of terms will likely be acceptable.

A simple very broad synonym search for a single word can be used but an algorithm can be used that incorporates grammar and semantic analysis for a longer query of several words. These algorithms analyze the original search query word-by-word to create an alternative search query by replacing where possible each word with an alternative word or query. The alternative queries are generated by linguistic or semantic similarity to the original query. Additionally or alternatively, a query may be replaced by a shorter query or a single word. These alternatives can generated according predefined rules, randomized from predefined lists or extracted from a relational database (e.g., WORDNET or a database created for a particular technology or technologies, industries or purposes, and perhaps a database in which the user might be given the options to select, modify or otherwise customize the dataset), which allows a range of synonyms, hypernyms, hyponyms or alternative queries to be identified for a very large range of words, for example.

Once the alternative query is generated it is this new query that is forwarded to one or more search engines or used to directly query a database web content. The results can be presented to the user as originally intended by the search engine or according to a wide range of currently used methods. As with standard search engines the results contain hypertext links so that a user can visit and explore the most interesting of the returned results.

After one set of results are presented a user can re-search with the original search query a number of times because a wide variety of alternative query results can be located due to the combinatorial nature of the process. For example, because terms in a search may have a number of potential alternatives (i.e., substitutes), a four (4) word query may have hundreds or thousands of potential searches for the same original search query.

Each generated search query may be narrow but will carry a differently nuanced meaning. By doing so, the disclosed embodiments produce more nuanced search results one or more of which might be better suited to a particular user's goal.

Performing a standard search with the original search query is offered as an option so the user can compare the results of a standard search with the results obtained from the alternative search query. Users can also select to have the results presented side-by-side for more direct comparison of a standard search and a search with a modified search query.

### BRIEF DESCRIPTION OF THE DRAWING FIGURES

Additional benefits and features of the invention will become apparent from a consideration of the following flowcharts and drawings, which together with the description and figures legends specify and show various embodiments of the presently disclosed search enhancement system.

FIG. 1 shows an exemplary interface of the search enhancement system in the form of an example web page (GOOSELESS.com).

FIG. 2 shows exemplary results of entering the phrase “best Chinese restaurant in New York” and selecting the FLYING GOOSE search style.

FIG. 3 shows exemplary results of entering the phrase “best Chinese restaurant in New York” and selecting the currently normal GOOGLE search style.

FIG. 4 is a flow chart for implementation of “FLYING GOOSE” algorithm.

FIG. 5 is a flow chart for implementation of “WILD GOOSE” algorithm.

FIG. 6 is a flow chart for implementation of “CLEVER GOOSE” algorithm.

FIG. 7 illustrates an exemplary embodiment of one computer architecture implementation.

FIG. 8 illustrates an implementation of the user interface for the search enhancement system whereby an alternative search phrase is generated and then displayed dynamically in a series of dials.

### DETAILED DESCRIPTION OF THE DISCLOSED SEARCH ENHANCEMENT SYSTEM

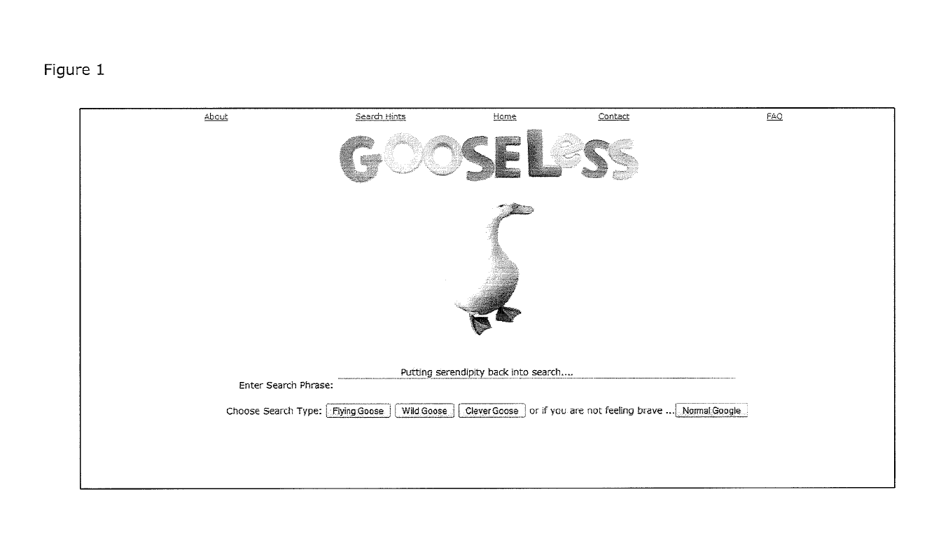

FIG. 1 shows an exemplary interface of the search enhancement system in the form of an example webpage for (GOOSELESS.com). Users in this particular implementation can select between three different styles of search “FLYING GOOSE”, “WILD GOOSE” and “CLEVER GOOSE” as well as comparing these results with a standard search (in this case with GOOGLE). Here, it should be noted that these names of search algorithms are merely convenient references to various parts of the disclosure, and have no technical or limiting meaning whatsoever.

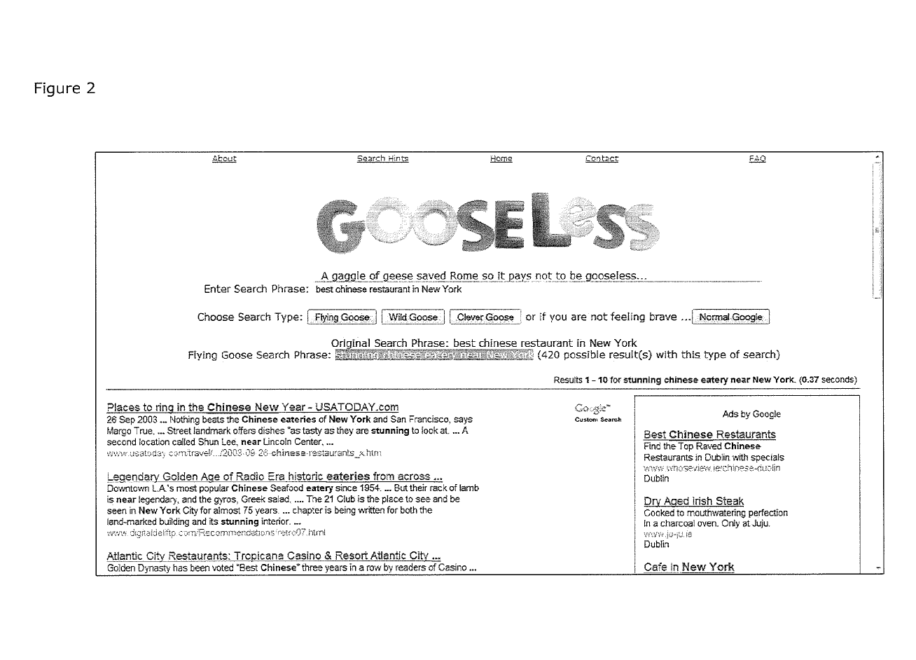

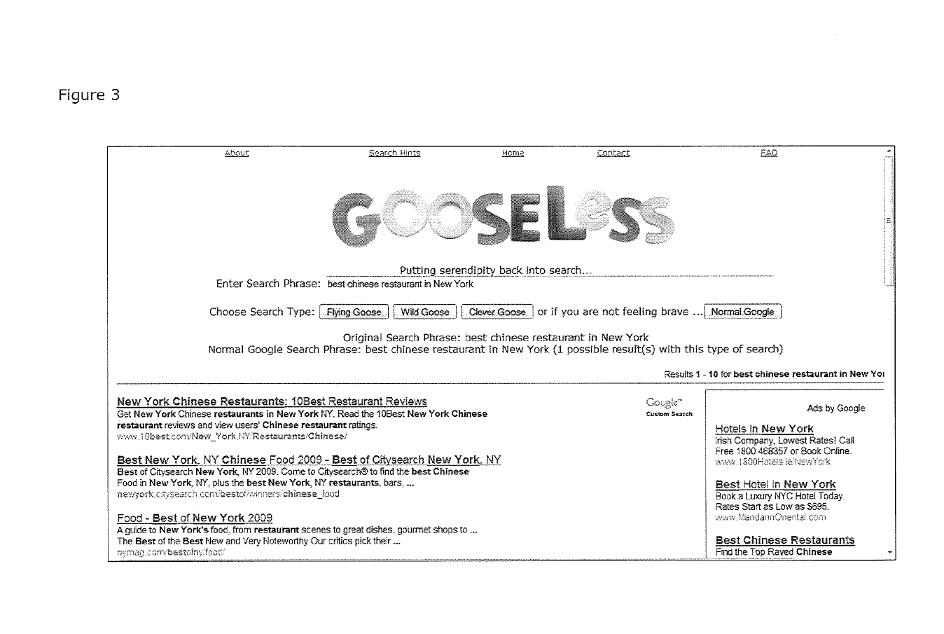

FIG. 2 shows exemplary results of entering the phrase “best Chinese restaurant in New York” and selecting the FLYING GOOSE search style. 420 alternative phrases have been identified and the first of these is listed i.e. “stunning Chinese eatery near New York.” Below this the web-page presents the search results in the normal fashion with hypertext links. To see the results for the other 419 options the user can keep clicking the FLYING GOOSE button or select another search style including the normal GOOGLE search option as shown in FIG. 3.

FIG. 3 illustrates the results of entering the phrase “best Chinese restaurant in New York” and selecting the normal GOOGLE search style. This presents a different set of results to the FLYING GOOSE option shown in FIG. 2. With a standard search such as this a user has to re-enter a new search phrase to get a different set of results, which is time consuming, frustrating and requires imagination.

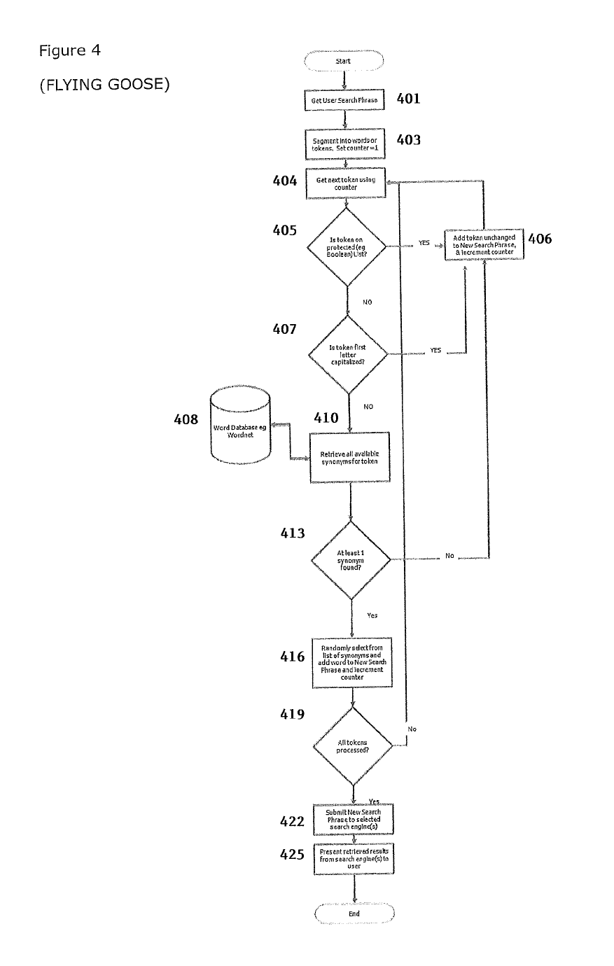

FIG. 4 is a flow chart for implementation of “FLYING GOOSE” algorithm. As shown in the flowchart of FIG. 4, an exemplary process includes a search query being obtained from a user's computer. (Step 401) Elements are determined by segmenting the obtained search query. (Step 403) As used herein, “elements” or tokens may be single words or multiple word queries. The search enhancement system may determine the elements based on rules of grammar, semantics and/or syntactics. For instance, in some cases, the use of inverted comma's that are commonly used in search engines to link words together, are used to form a single search token.

Each of the determined token is processed in an iterative fashion (i.e., one at a time). This can be done using a counter as part of the feedback loop. (Step 404) The search enhancement system determines if a token is included on a predefined exclusion list. (Step 405) If so (step 405, “Yes”), that token is included in a search query unchanged. (Step 406) The exclusion list is a lexicon of terms that should not be easily altered and/or should not be considered to have synonyms, hypernyms and/or hyponyms. These may include, for example, Boolean terms, pronouns and proper names.

For instance, the search enhancement system determines of the token has a first letter(s) that are capitalized. (Step 407) If so (step 407, “Yes”), the token is also included in the search query unchanged. (Step 406) In some cases, the exclusion list may be updated to include the token for future reference. By detecting capitalization, pronouns not included in the exclusion list and proper names may be detected. In some embodiments, hyphenation and capitalization may be detected.

If the token is not included on the exclusion list (step 405, “No”) or does not include capitalization (step 407, “No), the search enhancement system determines synonyms for the token from a synonym database 408 (e.g., WORDNET). (Step 410) If no synonyms are found (step 413, “No”), the token may be added to the search query unchanged. (Step 406) And, as above, the token may be used to update the exclusion list.

In some embodiments, alternatives are not limited to synonyms. Synonyms, hypernyms and hyponyms, as well as user customized alternative terms, can be included in and/or added to the database search and random selection process.

If it is determined that the token has at least one synonym (step 413, “Yes”), one of the synonyms is selected (step 416) and added to the search query (step 406). The synonym may be selected using a variety of techniques. In some cases, the synonym may be selected randomly or pseudo-randomly, as in the FLYING GOOSE algorithm of FIG. 4. In other cases, the synonym may be selected based on probabilistically (e.g., commonality). In other cases, the synonym may be selected based on popularity (e.g., frequency of use over a period of time) or indeed lack of popularity if rarely found sites are being sought by the user.

Steps 405 to 416 are repeated for all the elements included in the search query. (Step 404) If all the elements in the query have been processed (step 419, “Yes), the search query is submitted to one or more search engines. (Step 422) Results are then presented to the user. (Step 425)

Using the above-described process, a user can cycle through different variants by representing the same search query with the same or a different search style. For instance, the search query, “best Chinese restaurant in New York” may generate have over 30,000 search variants, but each providing a nuanced relatively narrow search result that likely would not have been created using the typical single invariant search of a conventional search engine.

A user can then cycle through all the different variants by representing the same search phrase with the same or a different search style. For the search phrase described above (“best Chinese restaurant in New York”) there are a total of 30,555 search variants that the current invention can generate compared to a single variant with a standard search engine such as GOOGLE.

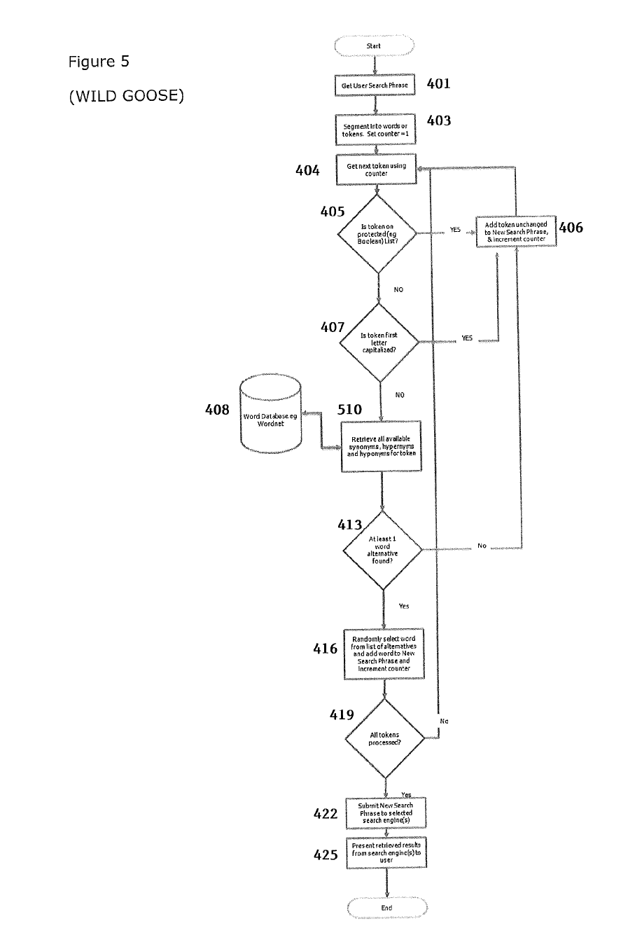

FIG. 5 shows the flowchart for the WILD GOOSE algorithm. It is largely the same as in FIG. 4, and like reference numbers reference similar features. For sake of brevity, these more or less common steps will not be described again. In this algorithm the net for alternative words is cast further afield and in addition to synonyms, hypernyms and hyponyms are included in the database search and random selection process. (Step 510)

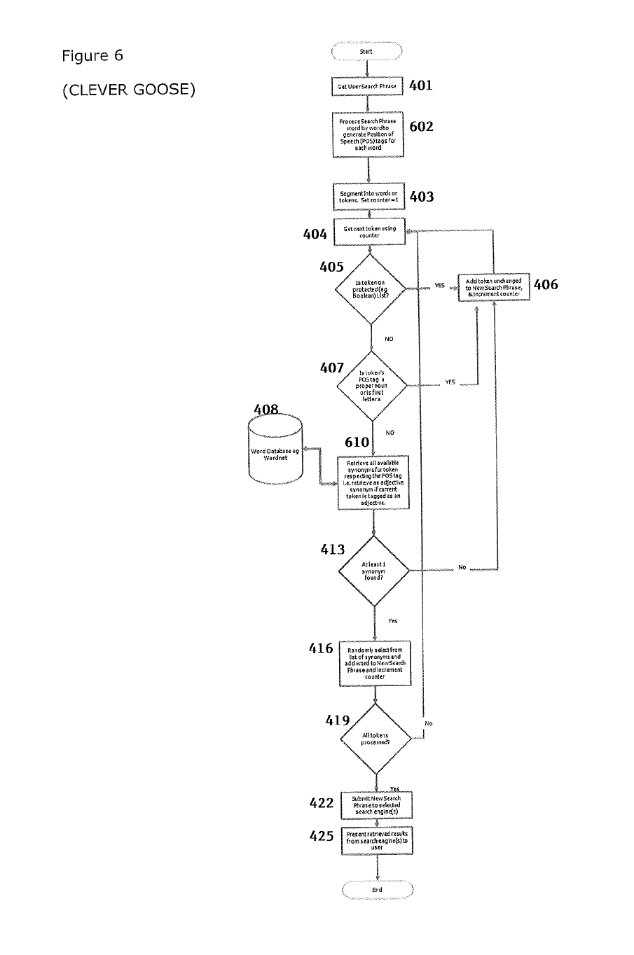

FIG. 6 shows the flowchart for the CLEVER GOOSE algorithm in which the original search phrase is analyzed to generate Position of Speech (POS) tags so as to generate a grammatical representation of the original search phrase (Step 602) and the synonyms for tokens with respect to the POS tag are retrieved (Step 610) are retrieved (e.g., retrieved an adjective synonym if a current token is tagged as an adjective). The other steps are the same or similar to those of FIG. 4. This can be achieved with a wide range of well known approaches such as the Stanford Parser (found on the Web at nlp.stanford.edu/software/lex-parser.shtml) or equivalent techniques which are well-known to anyone versed in the field of natural language processing. The result is a search phrase with matching set of POS or grammar tags. An example of such tags is shown below (from the Penn Treebank Project found on the Web at cis.upenn.edu/˜treebank/):

1. CC Coordinating conjunction

2. CD Cardinal number

3. DT Determiner

4. EX Existential there

5. FW Foreign word

6. IN Preposition or subordinating conjunction

7. JJ Adjective

8. JJR Adjective, comparative

9. JJS Adjective, superlative

10. LS List item marker

11. MD Modal

12. NN Noun, singular or mass

13. NNS Noun, plural

14. NNP Proper noun, singular

15. NNPS Proper noun, plural

16. PDT Predeterminer

17. POS Possessive ending

18. PRP Personal pronoun

19. PRP$ Possessive pronoun

20. RB Adverb

21. RBR Adverb, comparative

22. RBS Adverb, superlative

23. RP Particle

24. SYM Symbol

25. TO to

26. UH Interjection

27. VB Verb, base form

28. VBD Verb, past tense

29. VBG Verb, gerund or present participle

30. VBN Verb, past participle

31. VBP Verb, non-3rd person singular present

32. VBZ Verb, 3rd person singular present

33. WDT Wh-determiner

34. WP Wh-pronoun

35. WP$ Possessive wh-pronoun

36. WRB Wh-adverb

From the list of tags generated for the original search phrase word substitution can be constrained so that a word with multiple meanings such as “set”, which has the most number of distinct meanings of any English word and can in different contexts represent a noun, adjective or verb, can be substituted with a word from the same grammatical group, i.e., a noun is substituted with a noun synonym, an adjective with an adjective synonym, etc. In this way it is possible to retain more of the original sense of a search phrase and create alternatives that have a proper grammatical structure. Identification of proper nouns (as discussed above) is also assisted with this approach so those words identified as proper nouns which have not been properly capitalized can also be conserved in the alternative search phrase.

A range of additional features are implemented within this invention or available as options. These include providing a range of alternative search engines so that a user can select their favorite search engine (e.g., GOOGLE, YAHOO, BING, etc.) or combinations of search engines in a meta-search. Users can also narrow a search into a specific category such as images, videos, news or blogs.

Usually each word in a search phrase is treated as a distinct token for the purpose of finding alternative words. Words within inverted commas can be optionally treated as a single phrase as is commonly the case with search engines. Alternatively the words can be substituted but kept within inverted commas for the search process.

Where two or more capitalized words (or words identified as proper nouns on grammar analysis) can also be searched as a phrase to see if they relate to any particular topic, e.g., Film actor, Sports Celebrity, Film Title. For example if the name of a film actor is identified then the user is offered the option using an enhance search service in which the search phrase is modified with additional terms and Boolean modifiers to create a search that covers his/her films, news stories, videos of recent interview, etc. More simply if an appropriate match is found then the user can be offered to do a search just within this topic to maximize the chance of finding appropriate and interesting web pages.

Linguistic pre-analysis of a search phrase can also be applied to the situation where a user is searching for a particular person. Searches for people can be identified by looking for sequential words that appear in lists of first names and family names. Extensive lists of such data are available for example from Census databases. If a search identifies a sequence of one or more first names followed by a family name then specific search algorithms can implemented to search for that name amongst sites more relevant for searching for people, e.g., on social network sites (e.g., FACEBOOK or TWITTER), genealogy sites, school/alumni sites and similar sites. Such a search will typically return references to a list of people who share the same name. Individuals can be grouped by links between different accounts or shared data such as birth date or age. In this setting the user can then select between different individuals to find results relevant to the specific person they are looking for based on such linkages.

The GOOSELESS search service may be offered openly with no need to register, but can be an enterprise software package particularly where customized alternative words and phrases have been developed for a particular technology, industry or other area of endeavor. An additional option is to allow a user to choose to register and then they have the additional option of being able to store favorite searches and retrieve results from previous searches as these are stored in a database as a personal search history for each registered user, for instance.

The structure of the algorithms described in this application provides for a range of rules for word substitution. Merely by altering these rules, e.g., substituting only hyponyms for a narrower search or only hypernyms for a broader search, new search styles can be generated. A search for antonyms, words with an opposite meaning will produce a “reverse search engine” which looks for the opposite of what the user types in. Someone familiar with linguistics will easily be able on the basis of this disclosure to create a wide range of alternative search styles. These various search styles can be provided as a new button options but an advanced option allows users to select and configure a range of rules for how words are substituted creating a highly customized search experience.

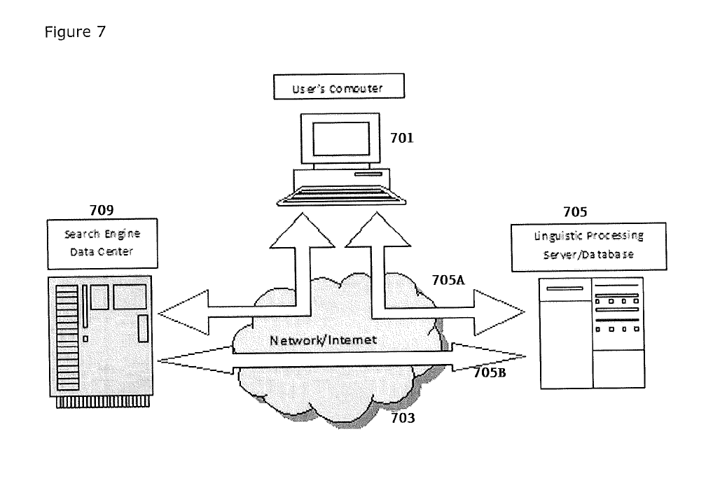

FIG. 7 illustrates an exemplary system diagram. This particular exemplary embodiment can have the advantage of not requiring any downloads, particularly downloads of large databases to a user's computer. It is also particularly suitable for use with mobile devices with limited processing power such as smart-phones or hand-held computers. Further, it can be used as a service or bureau, or a meta search engine through the use of APIs, enabling the user to select one or more search engines, for instance. The main linguistic algorithms and associated lexical databases are hosted on a dedicated server.

A user enters a search request via a web browser on a user computer (or mobile device) 701 connected to the Internet or other form of network, public or private (703). The search query may have an associated type, which is identified by the user or determined automatically based on the web page (e.g., embedded information, context).

The search query and type of search are submitted to the Linguistic Processing Server (via a URL encoded string for instance) (705). It is this component that constitutes the search enhancement system in this particular embodiment. This can be done once the query is fully typed in or done on a word by word basis or automatically submitted when the user stops typing for a configurable time (e.g., 500 msecs to 2 secs).

Receipt of the search requests triggers the search enhancement system 705 (reference here as a linguistic processing server and database) to determine substitutes for some or all of the elements (e.g., words) in the search request. The process of determining substitutes is described above with regard to FIG. 4 through 6.

Another web-page is then dynamically created by the server (using PHP or equivalent server-side scripting/programming language) or on the user's own computer (using tools such as Javascript or AJAX) in which the revised the search query are presented and code provided that facilitates retrieval of the search results and display on the user computer 701.

FIG. 7 thus illustrates an apparatus for searching for information implemented by a computer. This apparatus includes means for obtaining a first search query comprised of one or more search elements as represented by arrow 705A. It also includes means for obtaining one or more substitute search elements corresponding to at least one of the respective search elements and the database that is part of, connected to or associated with the linguistic processor 705. The linguistic processor 705 has a processor that is specifically programmed to be a specific purpose computer as means for determining, when information is received indicating a selection of one of the substitute elements, an alternative search query based on the first search query, the alternative search query substituting the selected substitute element for the respective search element in the first search query. As represented in the arrow 705B connecting the search engine 709 to the linguistic processor 705, there is means for providing the alternative search query to one or more search engines in the form of the interface to the network reaching out to the linguistic processor 709. Further, as explained above, the linguistic processor 704 provides means for presenting a result provided by the one or more search engines from the alternative search query by sending the results to a user computer or mobile device. In a practical embodiment, the interface including the dials and other GUIs might be provided by the linguistic processor 705, and the actual search results provided by the search engine(s) 709 as a web page displayed on the user's computer or phone 701.

FIG. 7 illustrates but one exemplary embodiment of a computer architecture implementation. Of course, the search enhancement system can be separate as shown, co-located or integral with either the search engine or the user's computer, or distributed among these three components or more components. For instance, the alternative terms can be pulled from a variety of databases that can be provided by the same entity that provides the linguistic processor 705 or by third party providers. Which database are used can be provided as an option to the user. In the instance where a user can define custom or specific purpose alternative terms databases, storing these locally on the user's computer 701 may be advantageous, but not required.

Coding approaches such as AJAX can also allow the New Search Query and search engine API code to be returned as a single webpage and the results dynamically populated once the results are retrieved from a search engine such as GOOGLE. As an alternative the linguistic server can directly request the search from search engine and send the resulting data as a web-page to the user's browser. Additionally it can be readily seen that the functions of the linguistic server 705 can be implemented as processing modules within the main search engine data center.

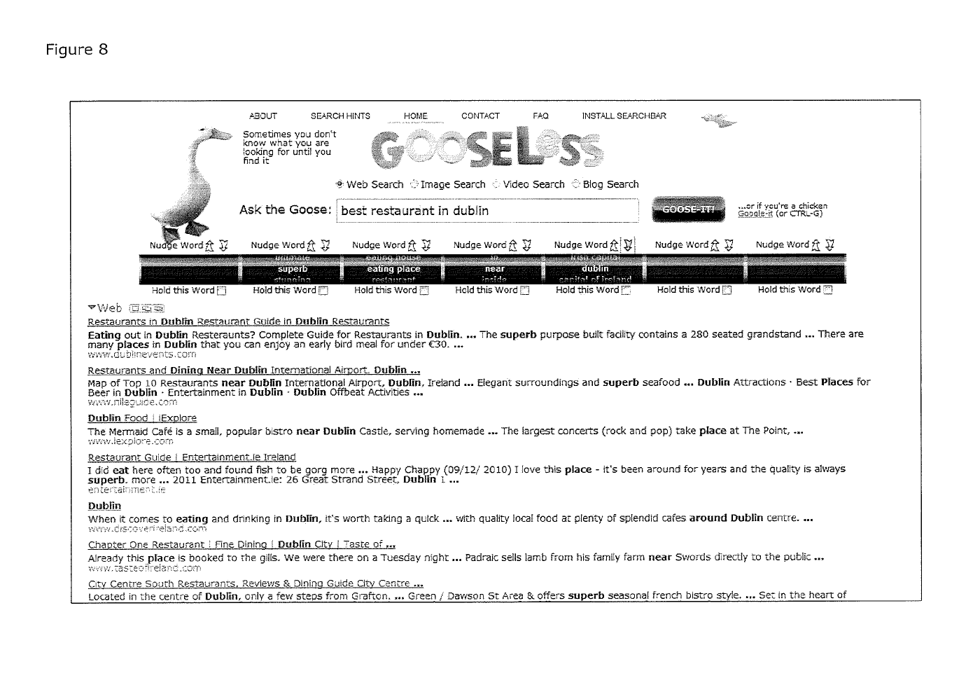

These determined substitutes for the elements are selectively displayed within individual lists within the browser window. In some embodiments, the lists are scrollable lists, rotating lists, or drop-down menus. Of course, other appearances can be given to the interface, such as pin wheels, ticker tapes, sliding scales, or nearly any other form wherein a list of one set of terms can be moved relative to a list of other terms. In other embodiments, the lists are presented in the form of graphical dials, each dial holding substitutes for each word as shown in FIG. 8.

Via the browser on the user's computer or phone 701, the user can then selectively move a specific dial up or down to fine tune the search query or in the manner of a slot-machine spin all the dials which will randomly rotate each dial to select an alternative from each dial's list via the “Goose-It” GUI in FIG. 8. In keeping with a slot machine idiom, the user can also select a hold button or check-box on the screen to stop a particular word from being randomized. The new modified search query can then be read off the sequence of dials after each change.

For any given generated alternative search query, search results can be requested from a search engine such as GOOGLE (as shown in FIG. 8) or any alternative search provider(s). This example provides a choice of searching the revised query according to a predefined algorithm or a standard search engine (in this case GOOGLE). Users can also be offered a choice of different linguistic processing algorithms or merely a single defined algorithm (not shown in FIG. 8). Additionally a user has the option selecting the type of search. FIG. 8 shows the option of web, image, video or blog searches. Such options also include selecting alternative search engines and search options for each.

This approach provides for more consumer interaction and for refinement of a search query. It also emphasizes the recreational and fun nature of the search process. This is an additional method of using the linguistic processing module where the final selection or randomization of a search query is under greater user control.

The present invention has been described by way of exemplary embodiments to which it is not limited. Variations and modifications will occur to those skilled in the art without departing from the present invention as defined in the claims appended hereto. For instance, rather than linguistic alternatives, for search inquires that are based on an image (rather than its metadata), alternative images can be presented. These images can be analogous to use of synonyms, hyponyms for a narrower search, hypernyms for a broader search, and antonyms for a reverse search. For instance, color, contrast, hue, perspective or other image variables can be changed, but additionally related images (e.g., people in various states of dress or disguises) can be classified and put into databases just like words are, and mentioned above with respect to WORDNET.

As to the claims, “comprising” should be interpreted as an open-ended transitional phrase. Also, those skilled in the art will realize that storage devices utilized to store program instructions and data can be distributed across a network, and stored on one or a plurality of tangible memory devices. As disclosed herein, embodiments and features can be implemented through computer hardware and/or software complied in a processor to form a specific purpose computer. Those skilled in the art will also realize that by utilizing conventional techniques known to those skilled in the art that all or a portion of the software instructions may be carried out by a dedicated circuit, such as a DSP, programmable logic array, or the like. Further, the steps of the disclosed methods can be modified in any manner, including by reordering steps and/or inserting or deleting steps, without departing from the principles of the invention. It is therefore intended that the specification and embodiments be considered as exemplary only.

What is claimed is:

1. A method for searching for information implemented by a computer, said method comprising:
obtaining a first search query comprised of one or more search elements;
obtaining one or more substitute search elements corresponding to at least one a respective one of the search elements;
when information is received indicating a selection of one of said substitute elements, determining an alternative search query based on the first search query, said alternative search query substituting the selected substitute element for the respective search element in the first search query;
providing the alternative search query to one or more search engines; and
presenting a result provided by the one or more search engines from the alternative search query.

2. The method of claim 1, wherein the first search query is obtained from a user computer.

3. The method of claim 1, wherein the first search query is comprised one or more words.

4. The method of claim 1, wherein the first search query is comprised one or more images.

5. The method of claim 1, wherein the one or more substitute elements are obtained from a relational database of alternative terminology based on the respective search element.

6. The method of claim 1, wherein the alternative search query is provided to the one or more search engines in response to the selection of the selected substitute element without further action by the user.

7. The method of claim 1, wherein selectable information corresponding to the one or more search elements is presented on a interactive graphic user interface in direct relation to the corresponding search element.

8. The method of claim 1, wherein the selected substitute element is selected randomly in response to a user input.

9. The method of claim 1, wherein presenting the result from the alternative search query includes replacing a result provided based on a previous search query generated from the first search query.

10. The method of claim 1, wherein presenting the result from the alternative search query includes at least one of synonyms, hyponyms, hypernyms, and antonyms for each search element.

11. An apparatus for searching for information implemented by a computer, said apparatus comprising:
means for obtaining a first search query comprised of one or more search elements;
means for obtaining one or more substitute search elements corresponding to at least one a respective one of the search elements;
means for determining, when information is received indicating a selection of one of said substitute elements, an alternative search query based on the first search query, said alternative search query substituting the selected substitute element for the respective search element in the first search query;
means for providing the alternative search query to one or more search engines; and
means for presenting a result provided by the one or more search engines from the alternative search query.

12. The apparatus of claim 11, further comprising a database of alternative search elements.

13. The apparatus of claim 11, further comprising a search engine.
